(19) United States
(12) Patent Application Publication
(10) Pub. No.: US 2019/0379053 A1
(43) Pub. Date: Dec. 12, 2019

(54) AQUEOUS ELECTRODE BINDERS FOR LITHIUM ION BATTERIES

(71) Applicant: SOLVAY SPECIALTY POLYMERS ITALY S.P.A., Bollate (IT)

(72) Inventors: Maurizio BISO, Milano (IT); Andrea Vittorio ORIANI, Bresso (IT); Serena CARELLA, Parabiago (IT); Paula COJOCARU, Legnano (IT)

(73) Assignee: SOLVAY SPECIALTY POLYMERS ITALY S.P.A., Bollate (IT)

(21) Appl. No.: 16/472,190

(22) PCT Filed: Dec. 18, 2017
(86) PCT No.: PCT/EP2017/083278

§ 371 Date: Jun. 20, 2019

(30) Foreign Application Priority Data
Dec. 20, 2016 (EP) 16205208.8

(51) Int. Cl. H01M 4/62; C08L 27/16; H01M 10/0525; H01M 4/04

(52) U.S. Cl. CPC H01M 4/623; C08L 27/16; H01M 2004/027; H01M 4/043; H01M 10/0525

(57) ABSTRACT

The present invention relates to an aqueous binder composition for use in the production of a lithium secondary battery electrode, a lithium secondary battery electrode formed therewith, and a lithium secondary battery including the same.

### CROSS-REFERENCE TO RELATED APPLICATIONS

This application claims priority to European application No. 16205208.8 filed on 20 Dec. 2016, the whole content of this application being incorporated herein by reference for all purposes.

### TECHNICAL FIELD

The present invention relates to an aqueous electrode binder composition for use in the production of a lithium secondary battery electrode, a lithium secondary battery electrode formed therewith, and a lithium secondary battery including the same.

### BACKGROUND ART

Electrodes for lithium-ion secondary batteries are usually fabricated by applying a slurry including an active material on a metal collector and drying said slurry. Examples of the slurry for forming an electrode include the one obtained by mixing and kneading a negative electrode active material, a binder, and a dispersion medium.

A large number of binder materials is known in the art. Polyvinylidene fluoride (PVDF) or polyvinyliden fluoride hexafluoropropylene (PVDF-HFP) copolymers have been found to have excellent chemical and mechanical properties when used as a binder material in a slurry for positive and negative electrodes. In particular, PVDF provides a good electrochemical stability and high adhesion to the electrode materials and to current collectors. PVDF is therefore a preferred binder material for electrode slurries. PVDF, however, has the disadvantage that it can only be dissolved in some specific organic solvents, which requires specific handling, production standards and recycling of the organic solvents in an environmentally-friendly way. commonly avoided so as to ensure more environmentally-friendly techniques.

As an example, water-based slurries for use as binders comprising carboxymethyl cellulose (CMC) and styrene-butadiene rubber (SBR) are known in the art. The publication of H. Buqa et al. “Study of a styrene butadiene rubber and sodium methyl cellulose as binder for negative electrodes in lithium-ion batteries” in Journal of Power Sources, 161 (2006), 617-622 describes the use of SBR and CMC as binders in aqueous solutions and their electrochemical performances compared to PVDF in organic solvent.

SBR/CMC binder has advantages in terms of viscosity and stability; nevertheless, it shows high electric resistance, and consequently reduced lifespan characteristics (EP2874212).

Binder compositions comprising SBR, CMC and resins dissolved or dispersed in water as a binder has also been attempted.

EP2555293 discloses an aqueous slurry comprising PVDF, SBR and CMC for use in the manufacture of electrodes for lithium ion batteries.

US 2016/079007 discloses a binder for power storage devices which comprises a polymer comprising a first recurring unit derived from an unsaturated carboxylic acid ester, a second recurring unit derived from an α,β-unsaturated nitrile compound and recurring units deriving from a monomer having a fluorine atom.

The electrode prepared by the use of the water-based slurries of the prior art are however characterized by poor flexibility and adhesion to the metal collector and to undesirable high variation in the thickness of the electrode after the required step of compacting the formed electrode, resulting in unsatisfactory low electrode density.

The need is thus felt for aqueous compositions for use in the preparation of electrodes for lithium ion batteries which advantageously enable the environmentally-friendly manufacturing of electrodes, said electrodes having enhanced flexibility, adhesion electrochemical stability and density.

### SUMMARY OF INVENTION

problems by providing, in a first instance, an aqueous binder composition [composition (C1)] for use in the preparation of electrodes for electrochemical devices, characterized by comprising:
at least one vinylidene fluoride (VDF) copolymer [polymer (A)] comprising recurring units derived from vinylidene fluoride (VDF) monomer and recurring units derived from at least one hydrophilic (meth)acrylic monomer (MA) of formula (I):

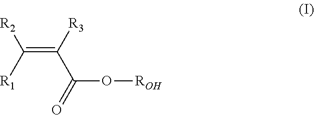

wherein each of R₁, R₂, R₃, equal or different from each other, is independently an hydrogen atom or a C₁-C₃ hydrocarbon group, and ROH is a hydrogen or a C₁-C₅ hydrocarbon moiety comprising at least one hydroxyl group;
at least one styrene-butadiene rubber (SBR); and
at least one cellulose-based dispersing agent.

In a second instance, the present invention pertains to the use of the aqueous binder composition [composition (C1)] of the invention in a process for the manufacture of an electrode for electrochemical devices [electrode (E)], said process comprising:

(i) providing a metal substrate having at least one surface;
(ii) providing an electrode-forming composition [composition (C2)] comprising at least one active material and an aqueous binder composition [composition (C1)] as defined above;
(iii) applying the composition (C2) provided in step (ii) onto the at least one surface of the metal substrate provided in step (i), thereby providing an assembly comprising a metal substrate coated with said composition (C2) onto the at least one surface;
(iv) drying the assembly provided in step (iii);
(v) submitting the dried assembly obtained in step (iv) to a compression step to obtain the electrode (E) of the invention.

[Electrode (E)] Obtainable by the Process of the Invention.

In a fourth instance, the present invention pertains to an electrochemical device comprising an electrode (E) of the present invention.

The Applicant of the present invention has surprisingly found that an aqueous composition comprising polymer (A), SBR and cellulose-based dispersing agent can be efficiently used as binder for an active material, which allows for easier handling and less environmental pollution and reduced costs in the preparation of electrodes while keeping the chemical and electrochemical advantages of said polymer (A).

The aqueous binder composition of the invention successfully provides for electrodes having improved flexibility and excellent adhesion to the metal collector without the use of additional adhesives.

No organic solvents or other additional components are needed or used to obtain the aqueous binder composition of the invention wherein the polymer (A), SBR and the cellulose-based dispersing agent are dispersed.

Moreover, the Applicant has found that the electrode of the present invention shows improved density and lower porosity in comparison with the electrodes prepared by using water-based binder compositions of the prior art. In particular, it has been demonstrated that the electrode of the invention has a low volume change after being subjected to the compression step required for obtaining the required density, thus demonstrating an improved dimensional stability of said electrode in comparison with those of the prior art.

### BRIEF DESCRIPTION OF DRAWINGS

FIG. 1 shows adhesion properties of the electrodes of Examples 1 to 6.

FIG. 2 shows bending properties of the electrodes of Examples 1 to 6.

FIG. 3 is a graph showing the results of test method for flexural properties of the electrodes of Examples 1 to 4.

FIG. 4 is a graph showing the volume change after calendering the electrodes of Examples 1 to 6.

### DESCRIPTION OF EMBODIMENTS

(VDF) And from at Least One Hydrophilic (Meth)Acrylic Monomer (MA).

The polymer (A) may further comprise recurring units derived from at least one other comonomer (C) different from VDF and from monomer (MA), as above detailed.

The comonomer (C) can be either a hydrogenated comonomer [comonomer (H)] or a fluorinated comonomer [comonomer (F)].

By the term “hydrogenated comonomer [comonomer (H)]”, it is hereby intended to denote an ethylenically unsaturated comonomer free of fluorine atoms.

Non-limitative examples of suitable hydrogenated comonomers (H) include, notably, ethylene, propylene, vinyl monomers such as vinyl acetate, as well as styrene monomers, like styrene and p-methylstyrene.

By the term “fluorinated comonomer [comonomer (F)]”, it is hereby intended to denote an ethylenically unsaturated comonomer comprising at least one fluorine atom.

The comonomer (C) is preferably a fluorinated comonomer [comonomer (F)].

Non-limitative examples of suitable fluorinated comonomers (F) include, notably, the followings:

(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins such as vinyl fluoride, 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE);
(e) (per)fluoroalkylvinylethers of formula CF₂═CFOR_{f1}, wherein R_{f1} is a C₁-C₆ fluoro- or perfluoroalkyl group, e.g. —CF₃, —C₂F₅, —C₃F₇;
(f) (per)fluoro-oxyalkylvinylethers of formula CF₂═CFOX₀, wherein X₀ is a C₁-C₁₂ oxyalkyl group or a C₁-C₁₂ (per)fluorooxyalkyl group having one or
(g) fluoroalkyl-methoxy-vinylethers of formula CF₂═CFOCF₂OR_{f2}, wherein R_{f2} is a C₁-C₆ fluoro- or perfluoroalkyl group, e.g. —CF₃, —C₂F₅, —C₃F₇ or a C₁-C₆ (per)fluorooxyalkyl group having one or more ether groups, e.g. —C₂F₅—O—CF₃;
(h) fluorodioxoles of formula:

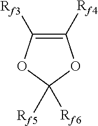

wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms, e.g. —CF₃, —C₂F₅, —C₃F₇, —OCF₃, —OCF₂CF₂OCF₃.

Most preferred fluorinated comonomers (F) are tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride, and among these, HFP is most preferred.

Should at least one comonomer (C) (preferably HFP) be present, the polymer (A) comprises typically from 0.05% to 25% by moles, preferably from 0.5% to 10% by moles, of recurring units derived from said comonomer(s) (C), with respect to the total moles of recurring units of polymer (A).

However, it is necessary that the amount of recurring units derived from vinylidene fluoride in the polymer (A) is at least 70.0 by moles %, preferably at least 75.0 by moles %, so as not to impair the excellent properties of vinylidene fluoride resin, such as chemical resistance, weatherability, and heat resistance. understood to mean that the polymer (A) may comprise recurring units derived from one or more than one hydrophilic (meth)acrylic monomer (MA) as above described. In the rest of the text, the expressions “hydrophilic (meth)acrylic monomer (MA)” and “monomer (MA)” are understood, for the purposes of the present invention, both in the plural and the singular, that is to say that they denote both one or more than one hydrophilic (meth)acrylic monomer (MA).

According to certain embodiments, polymer (A) consists essentially of recurring units derived from VDF, and from monomer (MA).

According to other embodiments, polymer (A) consists essentially of recurring units derived from VDF, from HFP and from monomer (MA).

Polymer (A) may still comprise other moieties such as defects, end-groups and the like, which do not affect nor impair its physico-chemical properties.

Non limitative examples of hydrophilic (meth)acrylic monomers (MA) are notably acrylic acid, methacrylic acid, hydroxyethyl (meth)acrylate, hydroxypropyl(meth)acrylate; hydroxyethylhexyl(meth)acrylates.

The monomer (MA) is more preferably selected among:
hydroxyethylacrylate (HEA) of formula:

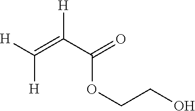

2-hydroxypropyl acrylate (HPA) of either of formulae:

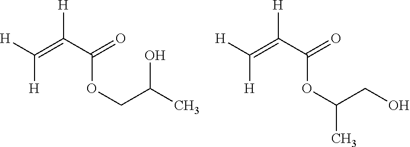

acrylic acid (AA) of formula:

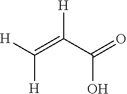

and mixtures thereof.

More preferably, the monomer (MA) is AA and/or HEA, even more preferably is AA.

Determination of the amount of (MA) monomer recurring units in polymer (A) can be performed by any suitable method. Mention can be notably made of acid-base titration methods, well suited e.g. for the determination of the acrylic acid content, of NMR methods, adequate for the quantification of (MA) monomers comprising aliphatic hydrogens in side chains (e.g. HPA, HEA), of weight balance based on total fed (MA) monomer and unreacted residual (MA) monomer during polymer (A) manufacture.

Polymer (A) comprises preferably at least 0.1, more preferably at least 0.2% by moles of recurring units derived from said hydrophilic (meth)acrylic monomer (MA) and/or polymer (A) comprises preferably at most 10.0% by moles, more preferably at most 7.5% by moles, even more preferably at most 5% by moles, most preferably at most 3% by moles of recurring units derived from said hydrophilic (meth)acrylic monomer (MA).

The cellulose-based dispersing agent contained in the electrode composition of the invention is selected from the group consisting of: carboxymethylcellulose, carboxyethylcellulose, aminoethylcellulose, oxyethylcellulose, or a mixture thereof.

In one embodiment, the present invention provides an aqueous binder composition (C1) wherein the amount by weight of the at least one polymer (A), of at least one SBR and of the at least one cellulose-based dispersing agent is substantially equal in the composition.

In this context, the term “substantially equal” means within +/−10 percent. preparing the aqueous binder composition (C1) as above defined which comprises mixing:
an aqueous dispersion comprising particles of at least one polymer (A) as above defined [dispersion (D)];
an aqueous suspension of at least one SBR [SBR suspension]; and
at least one cellulose-based dispersing agent.

The at least one cellulose-based dispersing agent can be added to the composition in the powdery form or as an aqueous solution, wherein the aqueous solution may typically comprise an amount by weight of the cellulose-based dispersing agent ranging from 0.1 to 10% in water.

Dispersion (D) comprises the at least one polymer (A) in an amount by weight ranging from 20% to 50%.

Dispersion (D) may be obtained by aqueous emulsion polymerization of VDF and the hydrophilic (meth)acrylic monomer (MA) and, optionally, the at least one comonomer (C) as above defined, in the presence of a persulfate inorganic initiator, at a temperature of at most 90° C., under a pressure of at least 20 bar.

The aqueous emulsion polymerization is typically carried out as described in the art (see e.g. EP3061145 (SOLVAY SA)).

For the purposes of the present invention, dispersion (D) can be used directly as obtained from the polymerization as above described. In this case, the dispersion (D) has a content of the at least one polymer (A) ranging from 20% to 30% by weight.

Optionally, subsequent to the emulsion polymerization, the method of making dispersion (D) may further include a concentration step. The concentration can be notably carried out with anyone of the processes known in the art. As an example, e concentration can be carried out by an ultrafiltration process well-known to those skilled in the art. See, for example, U.S. Pat. Nos. 3,037,953 and 4,369,266.

After the concentration step, the dispersion (D) may have a content of the at least one polymer (A) up to at most 50% by weight. stabilizer, preferably belonging to the class of alkylphenols ethoxylates. The amount of non-ionic surfactant in dispersion (D) can range from 2 to 20% by weight.

SBR is classified into two types: emulsion-polymerized SBR and solution-polymerized SBR. Examples of the emulsion-polymerized SBR include obtaining it as latex that may be dried and used as dry rubber. Examples of the solution-polymerized SBR include random SBR, block SBR, and symmetric block SBR, which have different types of copolymerization of styrene and butadiene. SBR also includes high styrene rubber, which has high compositional proportion of styrene and a high glass transition temperature (Tg). Further, SBR includes a modified SBR, which is copolymerized with an unsaturated carboxylic acid or an unsaturated nitrile compound. These types of SBR differ slightly from one another in physical properties (e.g., adhesion property, strength and thermal property), which difference is attributed to the copolymerization type and the styrene/butadiene copolymerization ratio. The type of SBR employed in the preparation of the aqueous binder composition (C1) of the present invention can be appropriately selected in accordance with the type of electrode active material to be employed for the preparation of electrodes.

Among the aforementioned types of SBR, an aqueous suspension prepared by dispersing emulsion- or solution-polymerized SBR in water is suitable for use in the preparation of the aqueous binder composition (C1) of the present invention, since the aqueous dispersion is readily mixed with the aqueous dispersion (D) and with the at least one cellulose-based dispersing agent.

The average particle size of SBR employed in the aqueous suspension of SBR of the present invention is preferably comprised in the range from 10 to 500 nm.

The SBR suspension typically comprises from 40% to 60% by weight of the at least one SBR in water.

The aqueous binder composition (C1) of the invention can be used in a process for the manufacture of an electrode for electrochemical devices

(i) providing a metal substrate having at least one surface;
(ii) providing an electrode-forming composition [composition (C2)] comprising at least one active material and the binder composition [composition (C1)] as defined above;
(iii) applying the composition (C2) provided in step (ii) onto the at least one surface of metal substrate provided in step (i), thereby providing an assembly comprising a metal substrate coated with said composition (C2) onto the at least one surface;
(iv) drying the assembly provided in step (iii);
(v) submitting the dried assembly obtained in step (iv) to a compression step to obtain the electrode (E) of the invention.

The metal substrate typically acts as a metal collector.

The metal substrate is generally a foil, mesh or net made from a metal such as copper, aluminium, iron, stainless steel, nickel, titanium or silver.

The electrode-forming composition (C2) provided in step (ii) may further comprise at least one additional additive, such as an electroconductivity-imparting additive.

The electroconductivity-imparting additive may be added in order to improve the conductivity of a resultant composite electrode layer formed by applying and drying of the electrode-forming composition of the present invention. Examples thereof may include: carbonaceous materials, such as carbon black, graphite fine powder and fiber, carbon nanotubes, graphene, and fine powder and fiber of metals, such as nickel and aluminium.

The electrode-forming composition (C2) may be obtained by adding and dispersing an active material, preferably in the form of powder, and optional additives, such as an electroconductivity-imparting additive, into composition (C1) as above detailed, and possibly by diluting the resulting composition with additional water.

A further object of the present invention is thus an electrode-forming composition [composition (C2)] comprising composition (C1) as above such as an electroconductivity-imparting additive.

When the electrode-forming composition (C2) is used for forming a positive electrode for an electrochemical device, the active material may comprise a composite metal chalcogenide represented by a general formula of LiMY₂, wherein M denotes at least one species of transition metals such as Co, Ni, Fe, Mn, Cr and V; and Y denotes a chalcogen, such as O or S. Among these, it is preferred to use a lithium-based composite metal oxide represented by a general formula of LiMO₂, wherein M is the same as above. Preferred examples thereof may include: LiCoO₂, LiNiO₂, LiNiₓCo₁₋ₓO₂ (0<x<1), and spinel-structured LiMn₂O₄.

As an alternative, in the case of forming a positive electrode for a lithium-ion secondary battery, the active material may comprise a lithiated or partially lithiated transition metal oxyanion-based electro-active material of formula M1M2(JO4)_{f}E_{1-f}, wherein M1 is lithium, which may be partially substituted by another alkali metal representing less than 20% of the M1 metals, M2 is a transition metal at the oxidation level of +2 selected from Fe, Mn, Ni or mixtures thereof, which may be partially substituted by one or more additional metals at oxidation levels between +1 and +5 and representing less than 35% of the M2 metals, including 0, JO4 is any oxyanion wherein J is either P, S, V, Si, Nb, Mo or a combination thereof, E is a fluoride, hydroxide or chloride anion, f is the molar fraction of the JO4 oxyanion, generally comprised between 0.75 and 1.

The M1M2(JO4)_{f}E_{1-f} active material as defined above is preferably phosphate-based and may have an ordered or modified olivine structure.

More preferably, the active material has formula Li₃₋ₓM′_{y}M″_{2-y}(JO4)₃ wherein 0≤x≤3, 0≤y≤2, M′ and M″ are the same or different metals, at least one of which being a transition metal, JO4 is preferably PO4 which may be partially substituted with another oxyanion, wherein J is either S, V, Si, Nb, Mo or a combination thereof. Still more preferably, the active material is a phosphate-based electro-active material of formula Li(FeₓMn₁₋ₓ)PO₄ wherein 0≤x≤1, wherein x is preferably 1 (i.e. lithium iron phosphate of formula LiFePO₄).

negative electrode for an electrochemical device, the active material may preferably comprise a carbonaceous material, such as graphite, activated carbon or a carbonaceous material obtained by carbonization of phenolic resin, pitch, etc. The carbonaceous material may preferably be used in the form of particles having an average diameter of ca. 0.5-100 μm.

Under step (iii) of the process of the invention, the composition (C2) is applied onto at least one surface of the metal substrate typically by any suitable procedures such as casting, printing and roll coating.

Optionally, step (iii) may be repeated, typically one or more times, by applying the composition (C2) provided in step (ii) onto the assembly provided in step (iv).

Under step (v), the dried assembly obtained at step (iv) is subjected to a compression step, such as a calendering process, to achieve the target porosity and density of the electrode (E).

Preferably, the dried assembly obtained at step (iv) is hot pressed, the temperature during the compression step being comprised from 25° C. and 130° C., preferably being of about 60° C.

Preferred target porosity for electrode (E) is comprised between 15% and 40%, preferably from 25% and 30%. The porosity of electrode (E) is calculated as the complementary to unity of the ratio between the measured density and the theoretical density of the electrode, wherein:
the measured density is given by the mass divided by the volume of a circular portion of electrode having diameter equal to 24 mm and a measured thickness; and
the theoretical density of the electrode is calculated as the sum of the product of the densities of the components of the electrode multiplied by their mass ratio in the electrode formulation.

Preferred measured density of electrode (E) of the invention is comprised between 0.7 and 2 g/cm³.

In a further instance, the present invention pertains to the electrode [electrode (E)] obtainable by the process of the invention.

The electrode (E) generally comprises:

from 92% to 97%;
an electroconductivity-imparting additive in an amount by weight of from 0% to 5%, preferably from 0.5% to 2.5%, more preferably of about 1%;
at least one polymer (A) in an amount by weight of from 0.1% to 5%, preferably from 0.5% to 2.5%;
at least one SBR in an amount by weight of from 0.1% to 5%, preferably from 0.5% to 2.5%;
at least one cellulose-based dispersing agent in an amount by weight of from 0.1% to 5%, preferably from 0.5% to 2.5%;
   the percentages by weight being indicated with respect to the total weight of the electrode (E).

Preferably, the amount of polymer (A), of SBR and of the at least one cellulose-based dispersing agent is substantially equal in the electrode (E).

In one preferred embodiment, the electrode (E) comprises
the active material in an amount by weight of 96%;
an electroconductivity-imparting additive in an amount by weight of 1%;
at least one polymer (A) in an amount by weight of 1%;
at least one SBR in an amount by weight of 1%;
at least one cellulose-based dispersing agent in an amount by weigh of 1%;
   the percentages by weight being indicated with respect to the total weight of the anode electrode (E).

The electrode (E) of the invention is particularly suitable for use in electrochemical devices as positive electrode and/or as negative electrode.

The Applicant has surprisingly found that the electrode (E) of the present invention shows excellent adhesion to current collector, excellent flexibility, improved electrode density, lower porosity, better electrical properties, better cycling stability and improved lamination characteristics towards coated separators used in electrochemical devices.

One object of the present invention thus pertains to an electrochemical device comprising an electrode (E) according to the present invention, negative electrode, or a positive electrode and a negative electrode.

Non-limiting examples of suitable electrochemical devices include secondary batteries.

For the purpose of the present invention, the term “secondary battery” is intended to denote a rechargeable battery.

The secondary battery of the invention is preferably an alkaline or an alkaline-earth secondary battery.

The secondary battery of the invention is more preferably a lithium-ion secondary battery.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### EXPERIMENTAL PART

### Raw Materials

Graphite, commercially available as Actilion 2 from Imerys S.A.;
Carbon black, commercially available as SC45 from Imerys S.A.;
Carboxymethylcellulose (CMC), commercially available as MAC 500LC from Nippon Paper;
SBR (1) suspension 40% by weight in water, commercially available as Zeon® BM-480B from ZEON Corporation;
SBR (2) suspension 48.9% by weight in water, commercially available as TRD102A from JSR Micro NV;
Dispersion (D1): 25% by weight in water VDF-AA (1% by moles)-HFP (3% by moles) polymer having an intrinsic viscosity of 0.104 l/g in DMF at 25° C.;

moles) having an intrinsic viscosity of 0.093 l/g in DMF at 25° C.

General Procedure for the Manufacture of Negative Electrodes

Negative electrodes were prepared by mixing the components as detailed below by using the following equipment:
mechanical mixer: planetary mixer (Speedmixer) and mechanical mixer of the Dispermat® series with flat PTFE lightweight dispersion impeller (for good mixing dispersion state),
film coater/Doctor Blade: Elcometer 4340 Motorised/Automatic Film Applicator,
vacuum oven: vacuum drying oven—BINDER APT line VD 53 with vacuum,
roll press: Precision 4″ Hot Rolling Press/Calender up to 100° C.

### Example 1: Negative Electrode According to the Invention

An aqueous composition was prepared by mixing 17.3 g of a 2% by weight solution of CMC in water, 16.5 g of deionized water, 33.1 g of graphite and 0.345 g of carbon black.

The mixture was homogenized by moderate stirring.

After about 1 h of mixing, 0.9 g of SBR (1) suspension and 1.4 g of dispersion (D1) were added to the composition and mixed again by low stirring for 1 h, giving the binder composition (B1).

A negative electrode was obtained by casting the binder composition (B1) so obtained on a 20 um thick copper foil with a doctor blade and drying the coating layer so obtained in an oven at temperature of 60° C. for about 60 minutes.

The thickness of the dried coating layer was about 220 μm.

The electrode was then hot pressed at 60° C. in a roll press to achieve the target porosity (26%) and density (1.6 g/cm³).

The negative electrode so obtained (electrode (E1)) had the following composition: 96% by weight of the active material (graphite), 1% by weight of carbon black, 1% by weight of CMC, 1% by weight of SBR (1) and 1% by weight of VDF-AA (1% by moles)-HFP (3% by moles) polymer.

### Example 2: Comparative Negative Electrode

solution of CMC, in water, 16.5 g of deionized water, 33.1 g of graphite and 0.345 g of carbon black.

The mixture was homogenized by moderate stirring.

After about 1 h of mixing, 1.7 g of SBR suspension was added to the composition and mixed again at low stirring for 1 h, giving the binder composition (BC1).

A negative electrode was obtained casting the binder composition (BC1) so obtained on a 20 um thick copper foil with a doctor blade and drying the coating layer so obtained in an oven at temperature of 60° C. for about 60 minutes.

The thickness of the dried coating layer was about 220 μm.

The electrode was then hot pressed at 60° C. in a roll press to achieve target porosity (26%) and density (1.6 g/cm³).

The negative electrode so obtained (electrode (EC1)) had the following composition: 96% by weight of the active material (graphite), 1% by weight of carbon black, 1% by weight of CMC, 2% by weight of SBR (1).

### Example 3: Comparative Negative Electrode

An aqueous composition was prepared by mixing 25.9 g of a 2% by weight solution of CMC in water, 7.3 g of deionized water, 33.1 g of graphite and 0.345 g of carbon black.

The mixture was homogenized by moderate stirring.

After about 1 h of mixing, 2.6 g of dispersion (D1) were added to the composition and mixed again by low stirring for 1 h, giving the binder composition (BC2).

A negative electrode was obtained casting the binder composition (BC2) so obtained on a 20 um thick copper foil with a doctor blade and drying the coating layer so obtained in an oven at temperature of 60° C. for about 60 minutes.

The thickness of the dried coating layer was about 220 μm.

The electrode was then hot pressed at 60° C. in a roll press to achieve target porosity (26%) and density (1.6 g/cm³).

composition: 95.5% by weight of the active material (graphite), 1% by weight of carbon black, 1.5% by weight of CMC, 2% by weight of VDF-AA (1% by moles)-HFP (3% by moles) polymer.

### Example 4: Comparative Negative Electrode

An aqueous composition was prepared by mixing 17.3 g of a 2% by weight solution of CMC, in water, 16.5 g of deionized water, 33.1 g of graphite and 0.345 g of carbon black.

The mixture was homogenized by moderate stirring.

After about 1 h of mixing, 0.9 g of SBR (1) suspension and 1.4 g of dispersion (Dcomp) were added to the composition and mixed again by low stirring for 1 h, giving the binder composition (BC3).

A negative electrode was obtained casting the binder composition (BC3) so obtained on a 20 um thick copper foil with a doctor blade and drying the coating layer so obtained in an oven at temperature of 60° C. for about 60 minutes.

The thickness of the dried coating layer was about 220 μm.

The electrode was then hot pressed at 60° C. in a roll press to achieve target porosity (26%) and density (1.6 g/cm³).

The negative electrode so obtained (electrode (EC3)) had the following composition: 96% by weight of the active material (graphite), 1% by weight of carbon black, 1% by weight of CMC, 1% by weight of SBR (1) and 1% by weight of VDF-HFP copolymer (5% by moles).

### Example 5: Negative Electrode According to the Invention

An aqueous composition was prepared by mixing 15.6 g of a 2% by weight solution of CMC in water, 11.9 g of deionized water, 29.9 g of graphite and 0.31 g of carbon black.

The mixture was homogenized by moderate stirring.

After about 1 h of mixing, 0.6 g of SBR (2) suspension and 1.6 g of dispersion

(D1) were added to the composition and mixed again by low stirring for 1 h, giving the binder composition (B2).

so obtained on a 20 um thick copper foil with a doctor blade and drying the coating layer so obtained in an oven at temperature of 60° C. for about 60 minutes.

The thickness of the dried coating layer was about 220 μm.

The electrode was then hot pressed at 60° C. in a roll press to achieve the target porosity (26%) and density (1.6 g/cm3).

The negative electrode so obtained (electrode (E2)) had the following composition: 96% by weight of the active material (graphite), 1% by weight of carbon black, 1% by weight of CMC, 1% by weight of SBR (2) and 1% by weight of VDF-AA (1% by moles)-HFP (3% by moles) polymer.

### Example 6: Comparative Negative Electrode

An aqueous composition was prepared by mixing 14.4 g of a 2% by weight solution of CMC, in water, 16.5 g of deionized water, 27.6 g of graphite and 0.29 g of carbon black.

The mixture was homogenized by moderate stirring.

After about 1 h of mixing, 1.2 g of SBR (2) suspension was added to the composition and mixed again at low stirring for 1 h, giving the binder composition (BC4).

A negative electrode was obtained casting the binder composition (BC4) so obtained on a 20 um thick copper foil with a doctor blade and drying the coating layer so obtained in an oven at temperature of 60° C. for about 60 minutes.

The thickness of the dried coating layer was about 220 μm.

The electrode was then hot pressed at 60° C. in a roll press to achieve target porosity (26%) and density (1.6 g/cm3).

The negative electrode so obtained (electrode (EC4)) had the following composition: 96% by weight of the active material (graphite), 1% by weight of carbon black, 1% by weight of CMC, 2% by weight of SBR (2).

Adhesion properties measurement on the negative electrodes

Peeling tests were performed on electrode (E1), electrode (E2), electrode (EC1), electrode (EC2), electrode (EC3) and electrode (EC4) by following the standard ASTM D903 at a speed of 50 mm/min at 20° C. in order to foil.

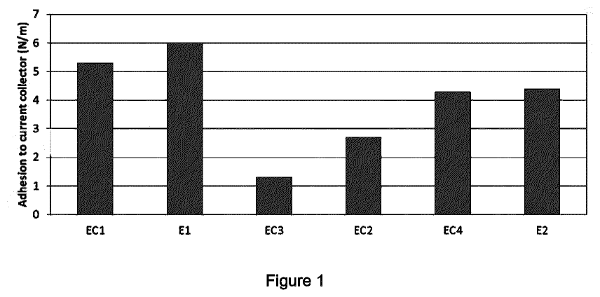

The results are shown in FIG. 1.

The results show that electrode (E1) and electrode (E2) according to the present invention have good values of adhesion to the electrode, comparable to that of the electrode comprising, respectively, only CMC and SBR (1) as electrode binder (electrode (EC1)) or CMC and SBR (2) as electrode binder (electrode (EC4)), while it shows higher adhesion than electrode (EC2) and electrode (EC3).

Bending Properties Measurement on the Negative Electrodes

A manual method was used to evaluate the cracks formation on samples tested by bending 3 cm wide strips of electrode (E1), electrode (EC1), electrode (EC2), electrode (EC3) on rods with decreasing diameters. The diameters of the rods used in the method were: 11 cm, 9 cm, 5.5 cm, 3.5 cm and 1.5 cm.

For each diameter the test is considered passed if no cracks develop after four bendings (two for each side).

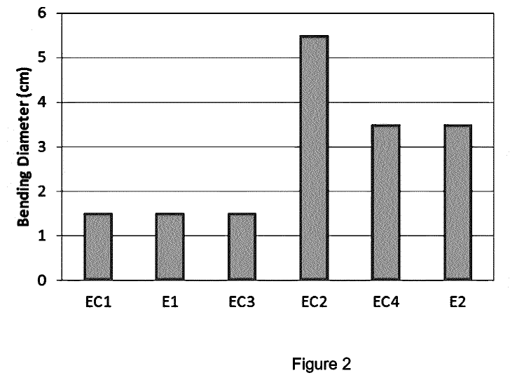

The results are summarized in FIG. 2.

The results show that the electrode (E1) according to the present invention has a bending performance which is comparable to that of electrode (EC1) and of electrode (EC3), while it shows higher bending properties adhesion than electrode (EC2). Electrode (E2) according to the present invention has a bending performance which is comparable to that of electrode (EC4).

Flexibility method and measurement on the negative electrodes

Negative electrode flexibility was evaluated according to ASTM D 790-10 Standard Test Method for Flexural Properties for electrode (E1), electrode (EC1), electrode (EC2), electrode (EC3).

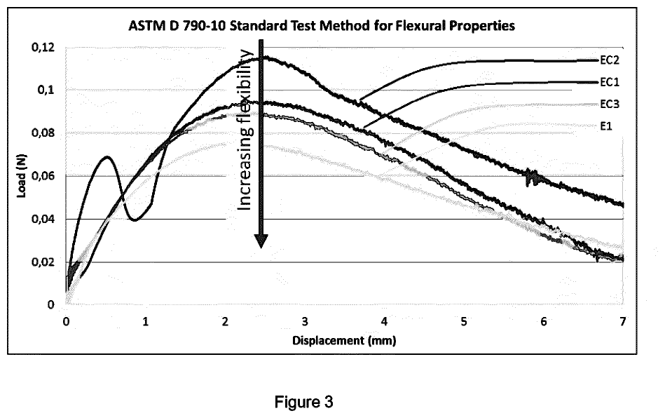

The results are shown in FIG. 3.

The results show that electrode (EC2) has poor flexibility performance, leading to cracks.

Electrode (E1) has higher flexibility that electrode (EC1) and electrode (EC3).

The volume change of negative electrodes (E1), (E2), (EC1), (EC2), (EC3) and (EC4) after calendering was monitored until no thickness variation was observed, according to the following procedure:

A stripe of each electrode was calendered at 60° C. to target density (active layer target density 1.6 g/cm³, i.e. porosity about 26%). The electrode thickness change was monitored for 48 hours after calendering, to record volume changes with time.

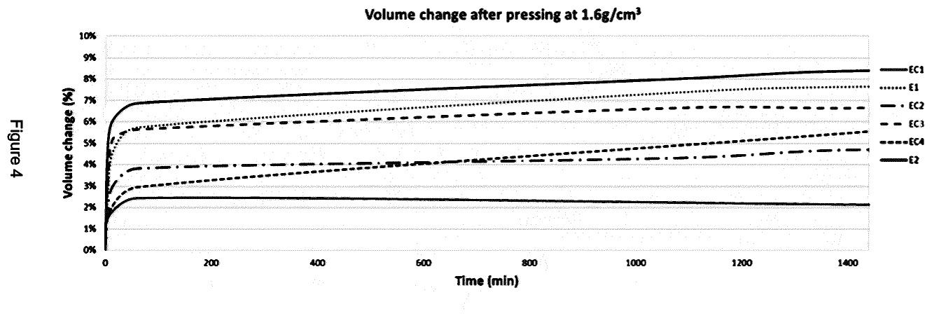

It was found that higher density and lower porosity were maintained for the negative electrodes (E1), (E2), (EC2) and (EC3) respect to electrode (EC1) and (EC4) that contains SBR and CMC only (see FIG. 4).

Conductivity of Binder Compositions

The aqueous binder compositions (B1), (BC1), (BC2) and (BC3) of examples 1 to 4, respectively, were used to manufacture samples by casting said compositions on a 50 μm thick Kapton® insulating foil with a doctor blade and drying the so obtained coating layer in an oven at temperature of 60° C. for about 60 minutes, leading to coating layer (L1), coating layer (LC1), coating layer (LC2) and coating layer (LC3).

Bulk resistivity was measured through a four-point probe.

The thickness of the dried coating layer was about 220 μm.

The samples (L1), (LC1), (LC2) and (LC3) were then hot pressed at 60° C. in a roll press to achieve target porosity (26%) and density 1.6 g/cm³.

Resistance value R of the calendered samples was measured by using the four-point probe method.

By using correction factors needed to take the thickness and shape of the 4-probe into consideration, the bulk resistivity (Ohms*cm²) of the samples was calculated according to the formula:

R bulk=R×t=4.532×R×t

where t is the coating thickness in cm.

It has been found that the sample obtained by the coating layer (L1) has higher conductivity with respect to both the samples obtained from (LC1) and from (LC3), see Table 1 below.

SBR, has the higher conductivity, as expected.

TABLE 1

| | Bulk |
|---|---|
| | resistivity |
| | (Ohms * cm²) |
| LC1 | 0.101 |
| L1 | 0.075 |
| LC3 | 0.122 |
| LC2 | 0.024 |

Manufacture of Batteries

A composite positive electrode using Lithium nickel manganese cobalt oxide (NMC, commercially available from UMICORE as Cellcore®NMC) as active material, SOLEF® 5130, commercially available from Solvay S.A., as PVDF binder and carbon black as the conductive additive was produced as follows.

A positive electrode paste was first made by adding 1.3 g of carbon black, 62.4 g of NMC material and 20 g of N-Methyl-2-pyrrolidone (NMP) to 16.25 g of a previously prepared 8% by weight SOLEF® 5130 suspension in NMP, and mechanically stirring the resulting mixture for 3 hours, using a Dispermat® stirrer operated at 800 rpm. The thus made paste was coated onto an 20 μm thick aluminium foil using a doctor blade casting technique and subsequently treated by 1 hour of heat drying at 130° C. under vacuum in an oven, to produce a positive electrode material having 96% by weight of NMC, 2% by weight of PVDF binder and 2% by weight of carbon. The thickness of the dried coating layer was about 190 μm.

The electrode was then hot pressed at 90° C. in a roll press to achieve target porosity (40%) and density 2.7 g/cm³.

Full coin cells (CR2032) were prepared in a glove box under Ar gas atmosphere by punching a small disk of the negative electrode (E1) or electrode (EC1) obtained in examples 1 and 2, respectively, as negative electrolyte used in the preparation of the coin cells was a standard 1M LiPF₆ in the binary solvents of EC:EMC=3:7 in % by weight, commercially available from BASF as LP57, with 2% by weight of VC as additive; polyethylene separators (commercially available from Tonen Chemical Corporation) were used as received.

After initial charge and discharge cycles at low current rate, cells were galvanostatically cycled at a constant current rate of 0.3 C to show capacity fade over cycling. The results are shown in Table 2.

It has been found that higher capacity is maintained for the coin cell comprising the negative electrode of the invention in comparison with that comprising the electrode (EC1) (binder made of CMC and SBR only).

TABLE 2

| | | | Capacity |
|---|---|---|---|
| | | Capacity | retention after |
| | | retention after | 100 cycles |
| | Initial | 25 cycles (% | (% of the |
| | discharge | of the initial | initial |
| | (mAh) | capacity) | capacity) |
| EC1 | 5.6 | 80.5 | 70.1 |
| E1 | 5.6 | 91.6 | 83.0 |

Wet Lamination

Two sandwiches comprising a polyethylene separator and, respectively, electrode (E1) and electrode (EC1) were sealed in coffee bags in vacuum after few drops of EC:DMC (1:1) were poured on the electrode surface. After about 30 minutes, lamination was performed at 80° C. 1 Mpa for 5 min.

Peeling tests were performed on the wet sandwich samples at 180° C. and 10 mm/min following ASTM D903.

It has been found that good adhesion was achieved when the separator was laminated with the electrode (E1) according to the invention, while very low adhesion was obtained between separator and the electrode

Table 3 here below.

TABLE 3

| | Adhesion |
|---|---|
| EC1 | Very low |
| E1 | Good |

1. An aqueous binder composition (C1) for use in the preparation of electrodes for an electrochemical devices, wherein the aqueous binder composition (C1) comprises:
at least one polymer (A), wherein polymer (A) is at least one vinylidene fluoride (VDF) copolymer comprising recurring units derived from vinylidene fluoride (VDF) monomer and recurring units derived from at least one hydrophilic (meth)acrylic monomer (MA) of formula (I): 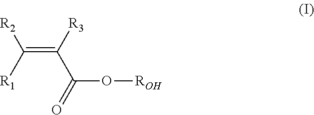
wherein each of R₁, R₂, R₃, equal or different from each other, is independently an hydrogen atom or a C₁-C₃ hydrocarbon group, and ROH is a hydrogen or a C₁-C₅ hydrocarbon moiety comprising at least one hydroxyl group;
at least one styrene-butadiene rubber (SBR); and
at least one cellulose-based dispersing agent.

2. The aqueous binder composition (C1) of claim 1, wherein polymer (A) further comprises recurring units derived from at least one comonomer (C), different from VDF and from monomer (MA), selected from hydrogenated comonomers (H) and fluorinated comonomers (F).

3. The aqueous binder composition (C1) of claim 2 wherein comonomer (C) is a fluorinated comonomer (F) selected from the group consisting of tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride.

4. The aqueous binder composition (C1) according to claim 2, wherein polymer (A) comprises recurring units derived from at least one comonomer (C) in an amount of from 0.05% to 25.0% by moles, with respect to the total moles of recurring units of polymer (A).

5. The aqueous binder composition (C1) according to claim 1, wherein the amount of recurring units derived from vinylidene fluoride in polymer (A) is at least 70.0% by moles.

6. The aqueous binder composition (C1) according to claim 1, wherein monomer (MA) is selected from the group consisting of acrylic acid, methacrylic acid, hydroxyethyl (meth)acrylate, hydroxypropyl(meth)acrylate; and hydroxyethylhexyl(meth)acrylates.

7. The aqueous binder composition (C1) according to claim 1, wherein polymer (A) comprises at least 0.1% by moles of recurring units derived from said hydrophilic (meth)acrylic monomer (MA) and/or polymer (A) comprises at most 10.0% by moles of recurring units derived from said hydrophilic (meth)acrylic monomer (MA).

8. The aqueous binder composition (C1) according to claim 1, wherein the at least one cellulose-based dispersing agent is selected from the group consisting of carboxymethylcellulose, carboxyethylcellulose, aminoethylcellulose, and oxyethylcellulose.

9. A process for preparing the aqueous binder composition (C1) according to claim 1, said method comprising mixing:
dispersion (D), wherein dispersion (D) is an aqueous dispersion comprising particles of at least one polymer (A);
an SBR suspension, wherein the SBR suspension is an aqueous suspension of at least one styrene-butadiene rubber; and
at least one cellulose-based dispersing agent.

10. An electrode-forming composition (C2) comprising
at least one active material,
an aqueous binder composition (C1) according to claim 1, and
optionally an electroconductivity-imparting additive.

11. A process for the manufacture of an electrode (E) for electrochemical devices, said process comprising:
applying a composition (C2) onto at least one surface of a metal substrate, thereby providing an assembly comprising a metal substrate coated with said composition (C2) onto the at least one surface, wherein composition (C2) is an electrode-forming composition according to claim 10;
drying the assembly; and
submitting the dried assembly to a compression step.

12. An electrode (E) obtainable by the process of claim 11.

13. The electrode (E) of claim 12 which comprises:
an active material in an amount by weight of from 80% to 99%;
an electroconductivity-imparting additive in an amount by weight of from 0.% to 5%;
at least one polymer (A) in an amount by weight of from 0.1% to 5%;
at least one SBR in an amount by weight of from 0.1% to 5%;
at least one cellulose-based dispersing agent in an amount by weight of from 0.1% to 5%;
the percentages by weight being indicated with respect to the total weight of the electrode (E).

14. An electrochemical device comprising the electrode (E) according to claim 13, characterized by comprising the electrode (E) as a positive electrode, a negative electrode, or a positive electrode and a negative electrode.

15. The electrochemical device of claim 14 that is a lithium secondary battery.

16. The aqueous binder composition (C1) according to claim 4, wherein polymer (A) comprises recurring units derived from at least one comonomer (C) in an amount of from 0.5% to 10.0% by moles, with respect to the total moles of recurring units of polymer (A).

17. The aqueous binder composition (C1) according to claim 5, wherein the amount of recurring units derived from vinylidene fluoride in polymer (A) is at least 75.0% by moles.

18. The aqueous binder composition (C1) according to claim 7, wherein polymer (A) comprises at least 0.2% by moles of recurring units derived from said hydrophilic (meth)acrylic monomer (MA) and/or polymer (A) comprises at most 3% by moles of recurring units derived from said hydrophilic (meth)acrylic monomer (MA).

19. The electrode-forming composition (C2) of claim 10, wherein the electroconductivity-imparting additive is carbon black.

20. An electrode (E) comprising the electrode-forming composition (C2) of claim 10 coated on a metal substrate.
